(19) United States
(12) Patent Application Publication
(10) Pub. No.: US 2019/0196846 A1
(43) Pub. Date: Jun. 27, 2019

(54) INFORMATION PROCESSING SYSTEM, CONTAINER MANAGEMENT APPARATUS, AND CONTAINER MANAGEMENT METHOD

(71) Applicant: FUJITSU LIMITED, Kawasaki-shi (JP)

(72) Inventors: Zhaogong Guo, Koto (JP); Junichi Yura, Kawasaki (JP); Masahide NODA, Kawasaki (JP); Tatsuro Matsumoto, Yokohama (JP)

(73) Assignee: FUJITSU LIMITED, Kawasaki-shi (JP)

(21) Appl. No.: 16/223,160

(22) Filed: Dec. 18, 2018

(30) Foreign Application Priority Data
Dec. 27, 2017 (JP) 2017-250517

(51) Int. Cl. G06F 9/445; G06F 9/455; G06F 8/60

(52) U.S. Cl. CPC G06F 9/44505; G06F 2009/45595; G06F 8/60; G06F 9/45558

(57) ABSTRACT

An information processing system includes a plurality of information processing apparatuses having a container virtualization infrastructure, each of the plurality of information processing apparatuses include a memory and a processor that executes a process including deploying an evaluation container on the information processing apparatus, the evaluation container including an evaluation program that evaluates a resource of the information processing apparatus, acquiring data regarding the resource in the information processing apparatus from the evaluation program, specifying, based on the data regarding the resource, one of the plurality of information processing apparatuses that satisfies a resource condition for a target container, and determining the specified information processing apparatus as a deployment destination for the target container.

### CROSS-REFERENCE TO RELATED APPLICATION

This application is based upon and claims the benefit of priority of the prior Japanese Patent Application No. 2017-250517, filed on Dec. 27, 2017, the entire contents of which are incorporated herein by reference.

### FIELD

The embodiments discussed herein are related to an information processing system, a container management apparatus, and a container management method.

### BACKGROUND

In recent years, container virtualization technology for loading and running a program on a server on a per-container basis has been widely used. The container virtualization technology is applied to, for example, a system in which a plurality of programs are distributed to a plurality of servers and deployed thereon.

In addition, to facilitate setting up such a system, a tool for automatically loading containers to predetermined servers that are deployment destinations has been often used.

However, if a server that is a deployment destination is not appropriately selected when the automatic loading tool is applied to the container virtualization technology, a program included in the container does not appropriately run in some cases.

Japanese Laid-open Patent Publication No. 2007-48315 is an example of the related art.

### SUMMARY

According to an aspect of the embodiments, an information processing system includes a plurality of information processing apparatuses having a container virtualization infrastructure, each of the plurality of information processing apparatuses include a memory and a processor that executes a process including deploying an evaluation container on the information processing apparatus, the evaluation container including an evaluation program that evaluates a resource of the information processing apparatus, acquiring data regarding the resource in the information processing apparatus from the evaluation program, specifying, based on the data regarding the resource, one of the plurality of information processing apparatuses that satisfies a resource condition for a target container, and determining the specified information processing apparatus as a deployment destination for the target container.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example configuration of a network and devices;

FIG. 2 is a diagram illustrating an example configuration of software;

FIG. 3 is a diagram illustrating an example configuration of containers;

FIG. 4 is a diagram illustrating an example module configuration of a server before the deployment of the containers;

FIG. 5 is a diagram illustrating an example module configuration of the server with containers deployed thereon;

FIG. 6 is a diagram illustrating an example module configuration of a server with containers deployed thereon;

FIG. 7 is a view illustrating an example of a loading configuration file;

FIG. 8 is a diagram illustrating an example module configuration related to container loading;

FIG. 9 is a diagram illustrating a virtual network example;

FIG. 10 is a diagram illustrating an example configuration of the network and the devices;

FIG. 11 is a view illustrating an example of a resource request file;

FIG. 12 is a diagram illustrating an example of loading of evaluation containers;

FIG. 13 is a diagram illustrating an example module configuration of a management device;

FIG. 14 is a flowchart illustrating the flow of a main process;

FIG. 15 is a flowchart illustrating the flow of an evaluation process (A);

FIG. 16 is a table illustrating an example of an evaluation result table;

FIG. 17 is a flowchart illustrating the flow of the main process;

FIG. 18 is a view illustrating an example of the loading configuration file;

FIG. 19 is a diagram illustrating an example configuration of a network and devices;

FIG. 20 is a view illustrating an example of a resource request file in Embodiment 2;

FIG. 21 is a flowchart illustrating the flow of an evaluation process (B);

FIG. 22 is a table illustrating an example of an evaluation result table in Embodiment 2;

FIG. 23 is a flowchart illustrating the flow of a main process in Embodiment 2;

FIG. 24 is a flowchart illustrating the flow of the main process in Embodiment 2; and

FIG. 25 is a functional block diagram of a computer.

### DESCRIPTION OF EMBODIMENTS

It is an object of an aspect of the embodiments to enable an appropriate container deployment destination to be determined automatically.

### Embodiment 1

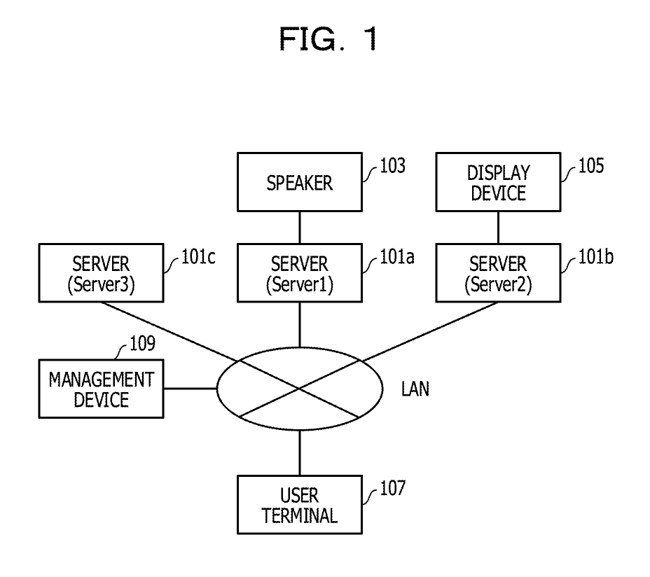

FIG. 1 illustrates an example configuration of a network and devices. Servers 101a to 101c (also referred to as servers 101) are connected to a local area network (LAN). The servers 101a to 101c provide a container operating environment. A speaker 103 is connected to the server 101a. A display device 105 is connected to the server 101b. The name of the server 101a is server1. The name of the server 101b is server2. The name of the server 101c is server3.

A user terminal 107 and a management device 109 are further connected to the LAN. The user terminal 107 is used when an instruction is issued to an application program to run on a server 101. The management device 109 is used to manage the servers 101a to 101c.

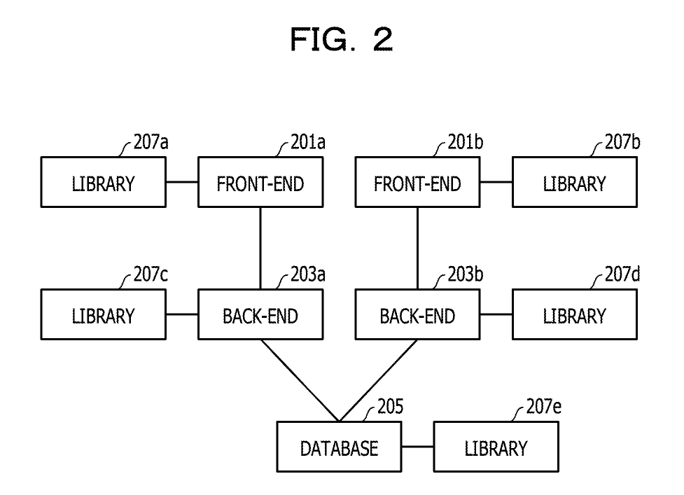

FIG. 2 illustrates an example configuration of a software group for implementing services for sound output and video output. In this example, the software group includes front-ends 201a and 201b, back-ends 203a and 203b, a database 205, and libraries 207a to 207e (also referred to as libraries 207).

The front-end 201a is an application program that outputs sound by using the speaker 103 in response to an instruction received from the user terminal 107. The library 207a is used in a process by the front-end 201a.

The front-end 201b is an application program that outputs video by using the display device 105 in response to an instruction from the user terminal 107. The library 207b is used in a process by the front-end 201b.

The database 205 manages sound data and video data. For example, the database 205 executes a process for reading out and providing the sound data and the video data stored in the memory of the database 205. The library 207e is used in a process by the database 205.

The back-end 203a is an application program that processes and provides the sound data in response to a request from the front-end 201a, the sound data being acquired from the database 205. The library 207c is used in a process by the back-end 203a.

The back-end 203b is an application program that processes and provides the video data in response to a request from the front-end 201b, the video data being acquired from the database 205. The library 207d is used in a process by the back-end 203b.

These pieces of software run in cooperation with each other, and the services are thereby implemented. In this example, each piece of software is deployed on a corresponding one of the server 101a and the server 101b. The server 101c is used for executing a container loading process (described later). However, the software may be deployed on the server 101c.

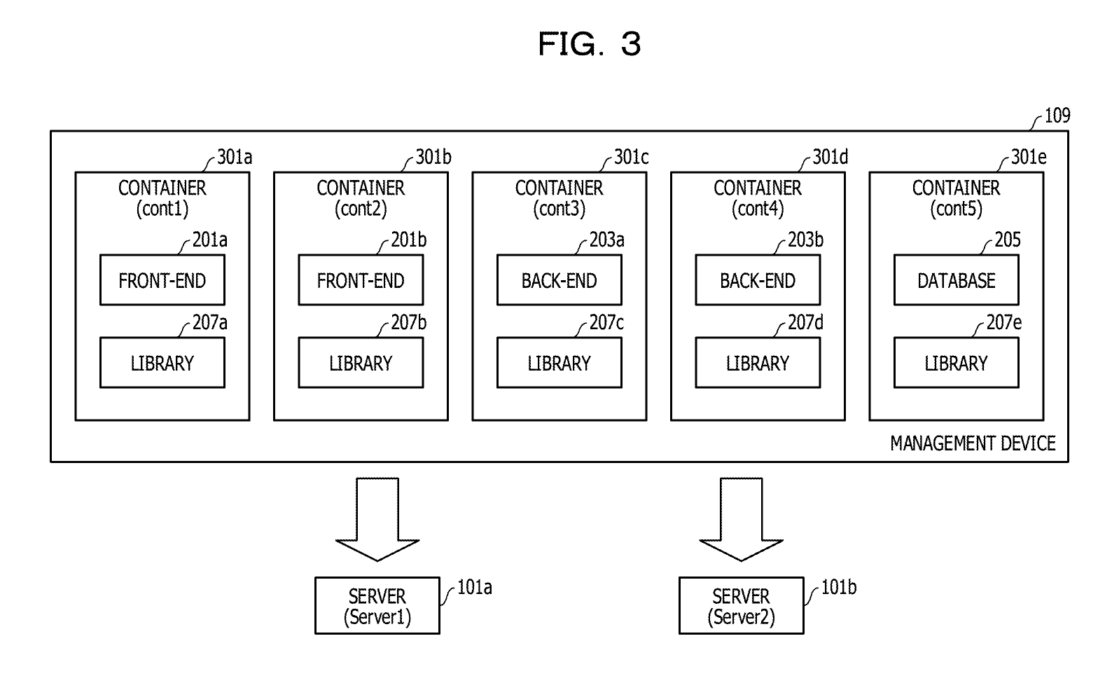

FIG. 3 illustrates an example of the configuration of containers 301a to 301e (also referred to as containers 301) used when the container virtualization technology is applied to the software group illustrated in FIG. 2. The containers 301 are prepared as images each including one or more programs. In this example, each of the containers 301a to 301e includes one application program. However, each container 301 may include a plurality of application programs. Each container 301 may also include one of the libraries 207 that is used by the application program. The container 301 may include accessory data other than the library 207.

For example, the container 301a includes the front-end 201a and the library 207a used by the front-end 201a. The container 301b includes the front-end 201b and the library 207b used by the front-end 201b. The container 301c includes the back-end 203a and the library 207c used by the back-end 203a. The container 301d includes the back-end 203b and the library 207d used by the back-end 203b. The container 301e includes the database 205 and the library 207e used by the database 205. The name of the container 301a is cont1. The name of the container 301b is cont2. The name of the container 301c is cont3. The name of the container 301d is cont4. The name of the container 301e is cont5.

As described above, if the library 207 used by the application program and the application program are included in one image, and if the container 301 is then deployed, an operating environment for the application program is thereby created. Accordingly, an effort for setting up the application program is saved.

The management device 109 holds the images of the containers 301a to 301e. The images of the containers 301a to 301e are loaded into the servers 101 that are deployment destinations (the server 101a and the server 101b in this example), and a system for providing services are thereby established.

Note that a guest operating system is included in a virtual server in server virtualization technology but is not included in container virtualization technology, and thus the size of an image is small in the container virtualization technology. Accordingly, load on a process for deploying software is reduced in one aspect, compared with the case of the virtual server.

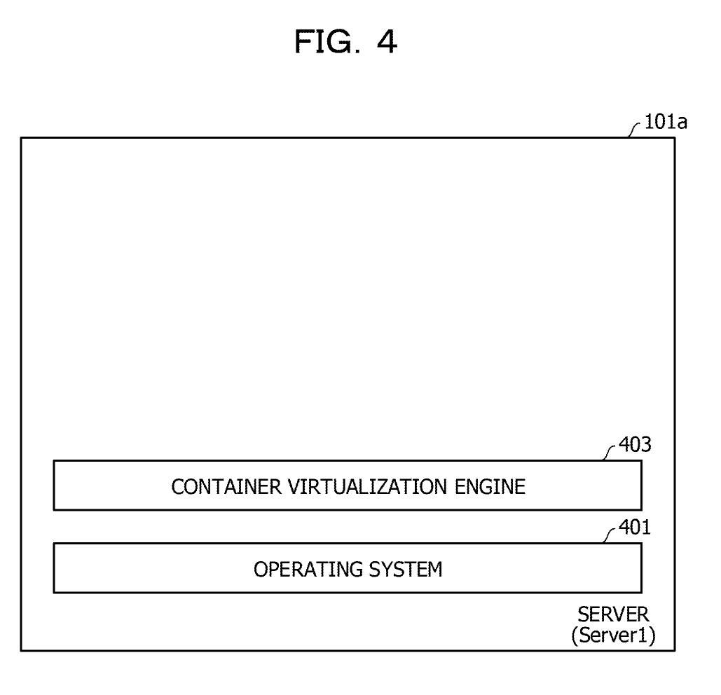

FIG. 4 illustrates an example module configuration of the server 101a before the deployment of the containers 301. As illustrated in FIG. 4, the containers 301 are loaded in a state where an operating system 401 and a container virtualization engine 403 are operated. The same holds true for the server 101b. The container virtualization engine 403 is, for example, a Docker engine. The container virtualization engine 403 corresponds to a container virtualization infrastructure.

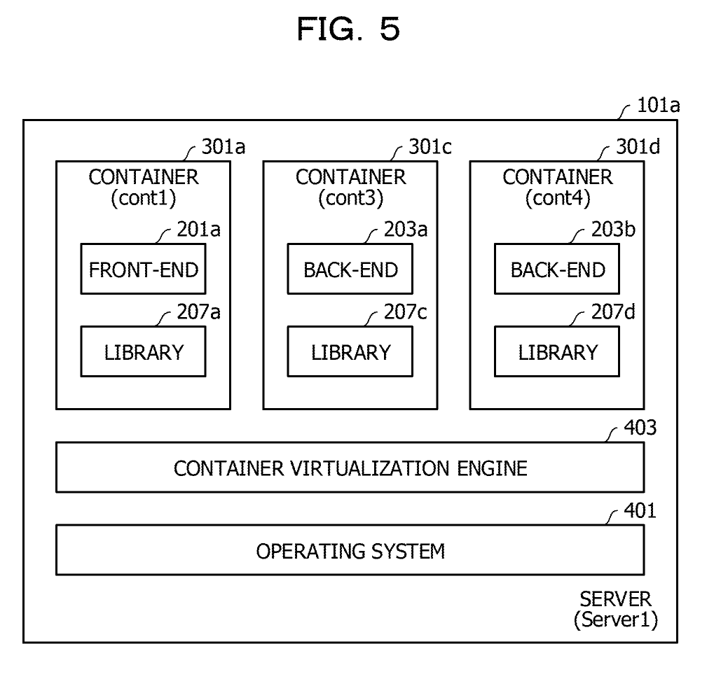

FIG. 5 illustrates an example module configuration of the server 101a with the containers 301 deployed thereon. In this example, the container 301a, the container 301c, and the container 301d are deployed on the server 101a. In a process by the front-end 201a included in the container 301a, sound is output from the speaker 103 connected to the server 101a.

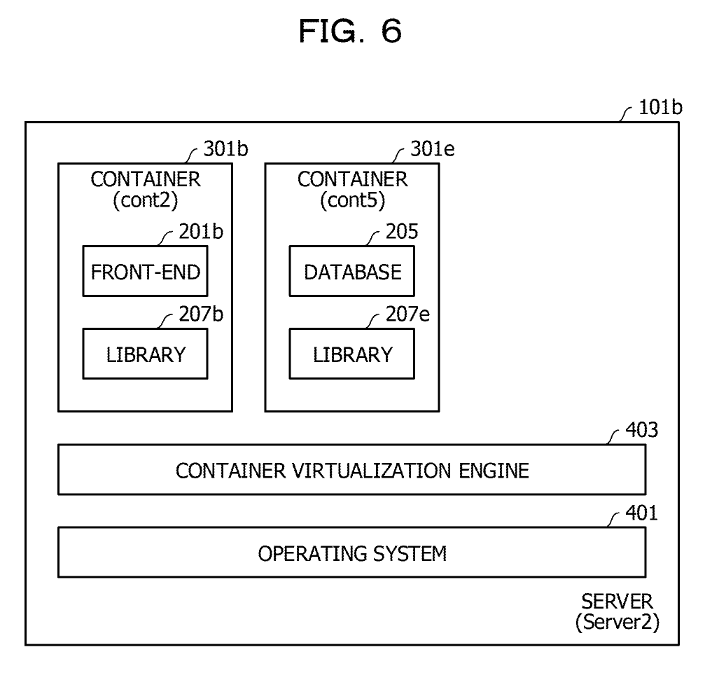

FIG. 6 illustrates an example module configuration of the server 101b with the containers 301 deployed thereon. In this example, the container 301b and the container 301e are deployed on the server 101b. In a process by the front-end 201b included in the container 301b, video is output from the display device 105 connected to the server 101b.

Regarding the loading of the containers 301 as described above, there is an automatic loading technology using a loading configuration file in which each container 301 that is a deployment target (deployment target container 301) is associated with one of the servers 101 that is a deployment destination (deployment destination server 101). First, the loading configuration file will be described.

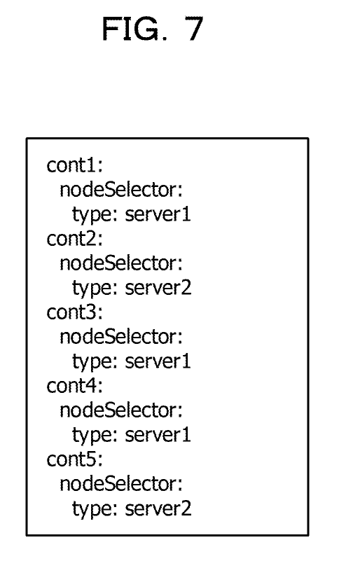

FIG. 7 illustrates an example of the loading configuration file. In the loading configuration file, the deployment destination server 101 is designated on a per deployment target container 301 basis. Each container 301 is a deployment target. For example, the deployment target container 301 is associated with the deployment destination server 101.

In this example, the server 101a by the server name of server1 is designated as the deployment destination for the container 301a by the container name of cont1. The server 101b by the server name of server2 is designated as the deployment destination for the container 301b by the container name of cont2. The server 101a by the server name of server1 is designated as the deployment destination for the container 301c by the container name of cont3. The server 101a by the server name of server1 is designated as the deployment destination for the container 301d by the container name of cont4. The server 101b by the server name of server2 is designated as the deployment destination for the container 301e by the container name of cont5. Each server 101 corresponds to a node.

If an administrator knows that the container 301a by the container name of cont1 includes an application program using the speaker 103 and that the speaker 103 is connected to the server 101a by the server name of server1, the administrator may appropriately designate the server 101a as the deployment destination for the container 301a. If the administrator knows that the container 301b by the container name of cont2 includes an application program using the display device 105 and that the display device 105 is connected to the server 101b by the server name of server2, the administrator may appropriately designate the server 101b as the deployment destination for the container 301b.

A container management tool such as Kubernetes refers to the loading configuration file, causes each container 301 to be loaded into the designated server 101, and starts the application program included in the loaded container 301. The container management tool is sometimes called a cluster management tool.

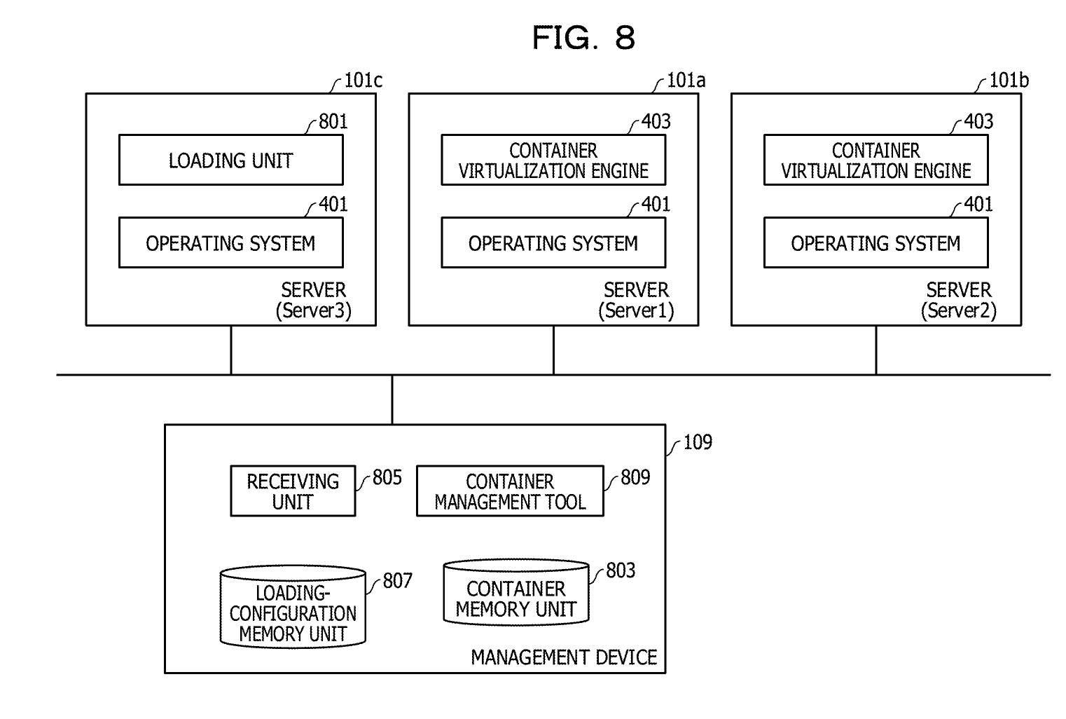

FIG. 8 illustrates an example module configuration related to container loading. The server 101c includes a loading unit 801. The loading unit 801 receives a container loading instruction in which a deployment target container 301 and a deployment destination server 101 (the server 101a or the server 101b in this example) are designated and loads the deployment target container 301 into the deployment destination server 101. The loading unit 801 is sometimes called an application programming interface (API) server. The container virtualization engine 403 and the loading unit 801 may be included in the same server 101. For example, the loading unit 801 may be included in the server 101a to omit the server 101c.

The management device 109 includes a container memory unit 803, a receiving unit 805, a loading-configuration memory unit 807, and a container management tool 809. The container memory unit 803 stores the images of the respective containers 301a to 301e. The receiving unit 805 receives the loading configuration file. The loading-configuration memory unit 807 stores the loading configuration file. The container management tool 809 deploys the containers 301 on the servers 101 based on the loading configuration file. For example, the container management tool 809 designates the containers 301 that are deployment targets and the servers 101 that are deployment destinations and instructs the loading unit 801 to load the containers 301.

After being loaded based on the loading configuration file illustrated in FIG. 7, the containers 301a to 301e are deployed in the states illustrated in FIGS. 5 and 6. The automatic loading of the containers 301 based on the loading configuration file is convenient for a case where, for example, appliance is loaded, that is, a system for a specific service is established.

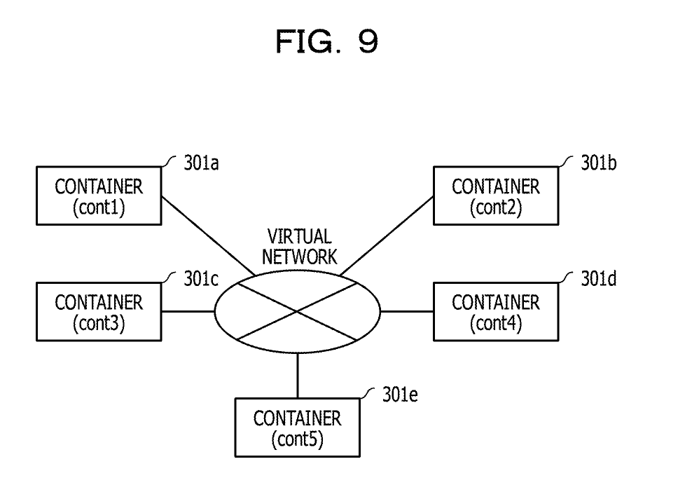

Note that the containers 301a to 301e are connected to each other via a virtual network as illustrated in FIG. 9. The containers 301a to 301e are respectively assigned IP addresses. For example, a container 301 at the transmitting end specifies a container 301 at the receiving end by designating an IP address. The virtual network is controlled in cooperation with the container virtualization engine 403.

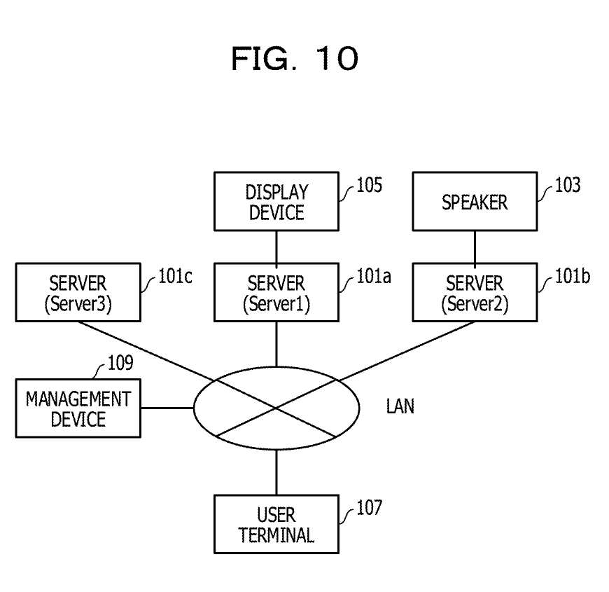

An example configuration of the network and the devices will be described by using FIG. 10, and the example is different from the example in FIG. 1. In the example in FIG. 1, the speaker 103 is connected to the server 101a. However, in this example, the display device 105 instead of the speaker 103 is connected to the server 101a. In addition, the display device 105 is connected to the server 101b in the example in FIG. 1, but the speaker 103 instead of the display device 105 is connected to the server 101b in this example.

Also in the example configuration in FIG. 10, if automatic loading of the containers 301a to 301e is performed by applying the loading configuration file in FIG. 7 to the example configuration, the containers 301a to 301e are deployed in the states in FIGS. 5 and 6 as described above. However, the speaker 103 is not connected to the server 101a in the example configuration in FIG. 10, and thus a failure, that is, sound output inability occurs in a process by the front-end 201a included in the container 301a. In addition, the display device 105 is not connected to the server 101b, and thus a failure, that is, video output inability occurs in a process by the front-end 201b included in the container 301b.

However, in the example configuration in FIG. 10, if the container 301a is deployed on the server 101b, sound may be output in the process by the front-end 201a included in the container 301a. In addition, if the container 301b is deployed on the server 101a, video may be output in the process by the front -end 201b included in the container 301b.

For example, in some cases, the loading configuration file has to be rewritten depending on the connection state of the devices. In addition, when the loading configuration file is generated, the connection state of the devices is not necessarily known. Further, in some cases, the connection state of the devices is changed at the stage of operations.

In this embodiment, the loading configuration file is generated to enable the application programs to run appropriately regardless of the connection state of the devices.

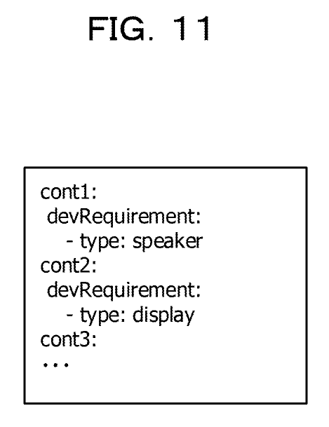

In this embodiment, the administrator prepares a resource request file illustrated in FIG. 11. The resource request file designates a device to be used on a per container 301 basis. For example, the name of the container 301 and the type of the device are associated with each other. The designated type of the device is an example of a resource condition requested for running the container 301.

This example illustrates that the speaker 103 is a necessity for the container 301a by the container name of cont1 and that the display device 105 is a necessity for the container 301b by the container name of cont2.

An overview of a process by a dynamic deployment tool provided to the management device 109 in this embodiment will be described. The dynamic deployment tool generates a loading configuration file to satisfy resource conditions in a resource request file. The dynamic deployment tool thus first deploys evaluation containers on the server 101a and the server 101b, respectively. The evaluation containers are used to evaluate the resources of the servers 101.

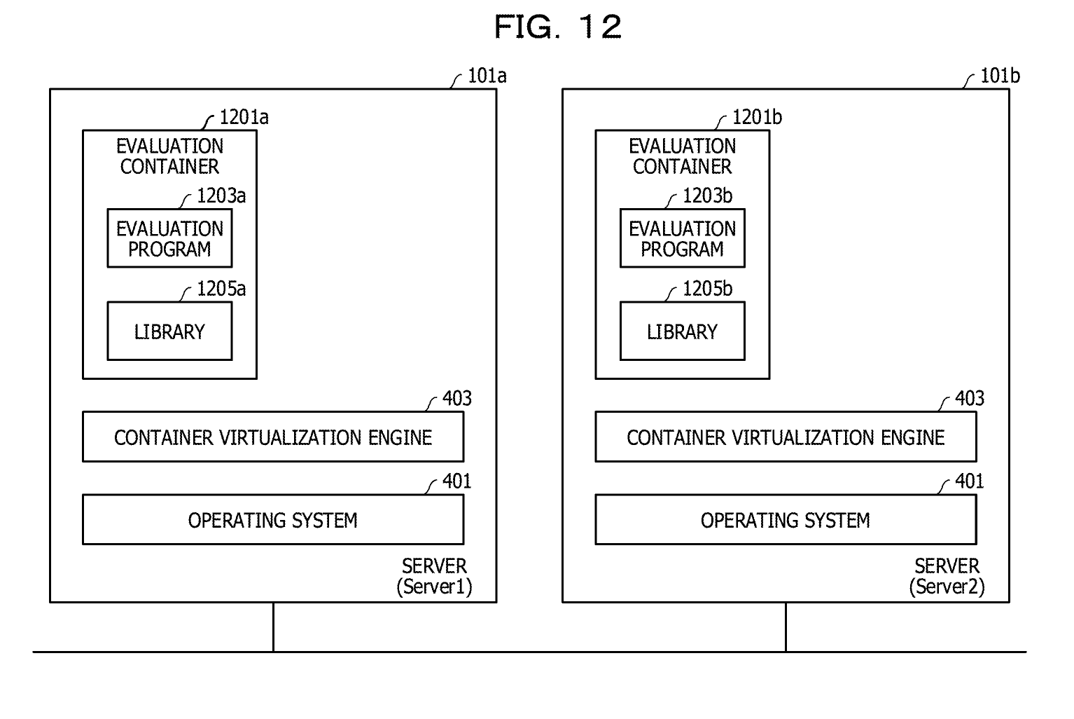

FIG. 12 illustrates an example of loading of evaluation containers 1201a and 1201b (also referred to as evaluation containers 1201). In this example, the servers 101a and 101b are candidate container deployment destinations. The evaluation containers 1201a and 1201b are thus loaded into the servers 101a and 101b, respectively.

The evaluation containers 1201a and 1201b respectively include evaluation programs 1203a and 1203b (also referred to as evaluation programs 1203) and also respectively include libraries 1205a and 1205b (also referred to as libraries 1205). Each evaluation program 1203 uses a corresponding one of the libraries 1205. When each evaluation container 1201 is loaded, the corresponding evaluation program 1203 verifies a resource in the corresponding server 101. In this example, the type of a device connected to the server 101 is identified and included in an evaluation result.

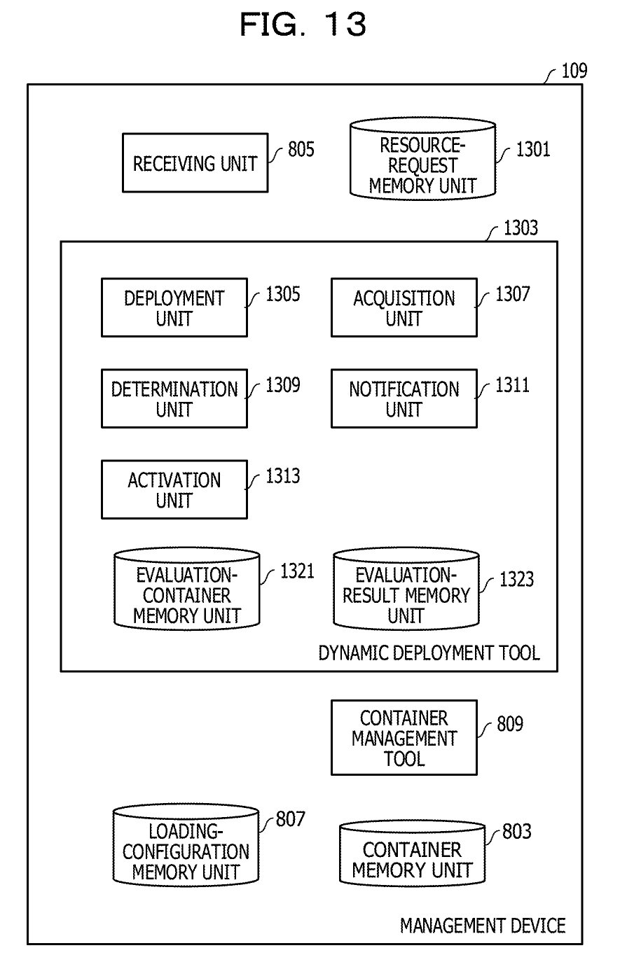

Hereinafter, the operation of the management device 109 according to this embodiment will be described. FIG. 13 illustrates an example module configuration of the management device 109. The management device 109 includes a resource-request memory unit 1301 and a dynamic deployment tool 1303 in addition to the container memory unit 803, the receiving unit 805, the loading-configuration memory unit 807, and the container management tool 809 that are described by using FIG. 8.

The receiving unit 805 receives a resource request file. The resource-request memory unit 1301 stores the resource request file. The dynamic deployment tool 1303 acquires evaluation results from the evaluation programs 1203 and determines deployment destinations for the containers 301 based on the resource request file and the evaluation results. The dynamic deployment tool 1303 writes the deployment destinations for the containers 301 in the loading configuration file.

The dynamic deployment tool 1303 includes a deployment unit 1305, an acquisition unit 1307, a determination unit 1309, a notification unit 1311, an activation unit 1313, an evaluation-container memory unit 1321, and an evaluation-result memory unit 1323.

The deployment unit 1305 deploys the evaluation containers 1201 on the respective servers 101. The acquisition unit 1307 acquires evaluation results from the respective evaluation programs 1203. The determination unit 1309 determines the deployment destinations for the containers 301. The notification unit 1311 outputs a resource shortage notification. The activation unit 1313 activates the container management tool 809. The evaluation -container memory unit 1321 stores the evaluation containers 1201. The evaluation-result memory unit 1323 stores an evaluation result table.

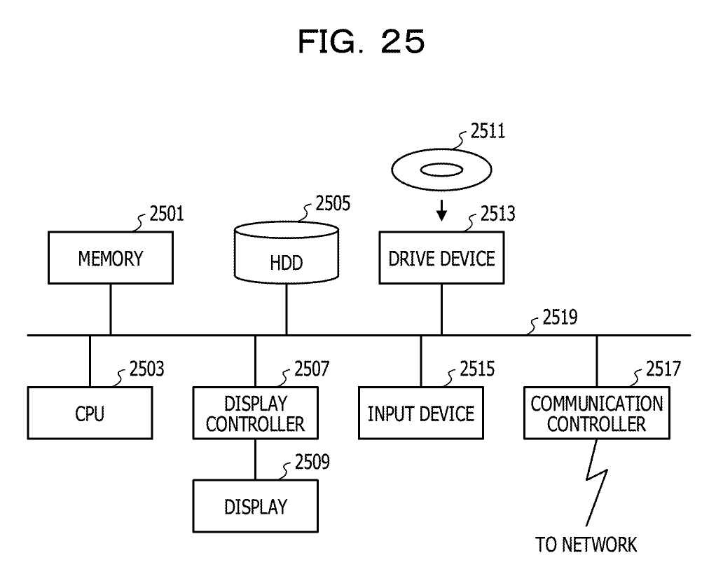

The receiving unit 805, the deployment unit 1305, the acquisition unit 1307, the determination unit 1309, the notification unit 1311, and the activation unit 1313 that are described above are implemented by using hardware resources (for example, FIG. 25) and programs causing a central processing unit (CPU) 2503 to execute processes (described later).

The resource-request memory unit 1301, the evaluation-container memory unit 1321, the evaluation-result memory unit 1323, the container memory unit 803, and the loading-configuration memory unit 807 that are described above are implemented by using the hardware resources (for example, FIG. 25).

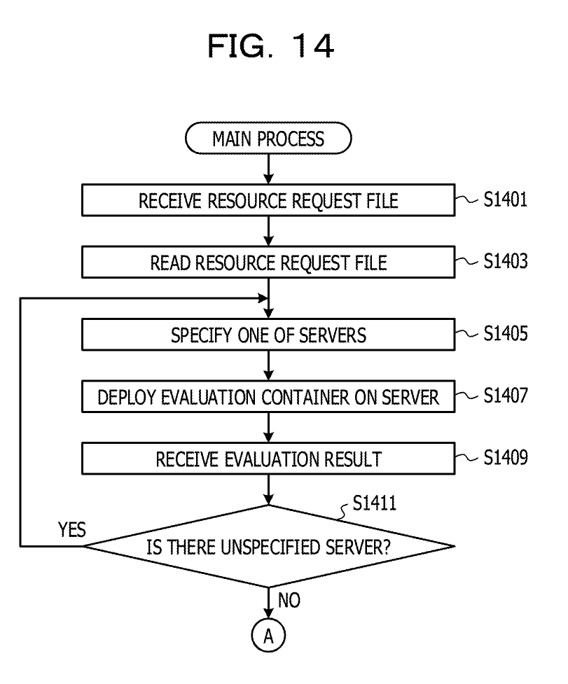

A process by the management device 109 will be described. FIG. 14 illustrates the flow of a main process. The receiving unit 805 receives a resource request file via a storage medium or a communication medium, for example, in accordance with an operation performed by the administrator and stores the received resource request file in the resource-request memory unit 1301 (S1401).

The deployment unit 1305 reads the resource request file (S1403) and specifies the name of one of the servers 101 included in text data read from the resource request file (S1405).

The deployment unit 1305 deploys one of the evaluation containers 1201 on the server 101 (S1407). For example, the deployment unit 1305 transmits an instruction to load the evaluation container 1201 into the server 101 to the loading unit 801.

When the evaluation container 1201 is loaded into the server 101, a process by the evaluation program 1203 included in the evaluation container 1201 is automatically started.

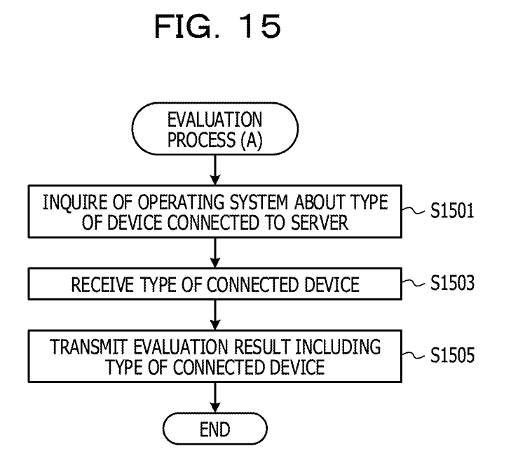

An evaluation process (A) by the evaluation program 1203 will be described. FIG. 15 illustrates the flow of the evaluation process (A). A functional unit implemented by executing the process by the evaluation program 1203 is hereinafter referred to as an evaluation unit.

The evaluation unit inquires of the operating system 401 about the type of a device connected to the server 101 (S1501).

The evaluation unit receives a reply regarding the type of the connected device from the operating system 401 (S1503) and transmits an evaluation result including the type of the device to the dynamic deployment tool 1303 (S1505). The evaluation process (A) is then terminated. After the end of the evaluation program 1203, the evaluation container 1201 disappears.

Referring back to the description regarding the main process, the acquisition unit 1307 receives the evaluation result from the evaluation program 1203 and updates the evaluation result table (S1409). For example, the acquisition unit 1307 adds a record to the evaluation result table and sets the evaluation result in the added record. In this example, the presence or absence of each device is set.

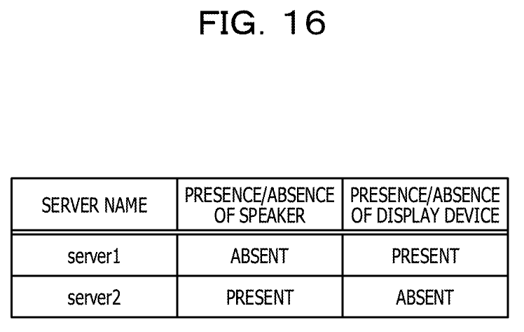

FIG. 16 illustrates an example of the evaluation result table. The evaluation result table in this example has records each associated with one of the servers 101. Each record in the evaluation result table has a field where the name of the server 101 is set, a field where the presence or absence of the speaker 103 is set, and a field where the presence or absence of the display device 105 is set.

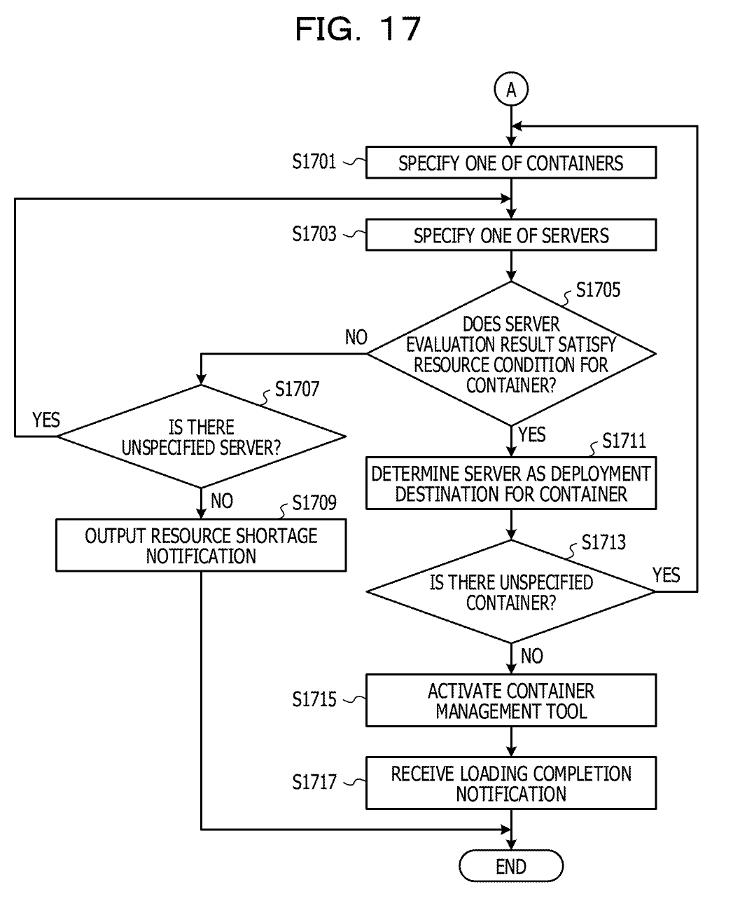

Referring back to the description regarding FIG. 14, the deployment unit 1305 judges whether there is an unspecified server 101 (S1411). If the deployment unit 1305 judges that there is an unspecified server 101, the process returns to step S1405 and repeats the above described steps. In contrast, if the deployment unit 1305 judges that there is not an unspecified server 101, the process moves to step S1701 illustrated in FIG. 17 via a connector A.

FIG. 17 will be described. The determination unit 1309 specifies one of the containers 301, for example, based on the resource request file (S1701).

The determination unit 1309 specifies one of the servers 101 (S1703). Based on the result of the evaluation of the server 101 and the resource request file, the determination unit 1309 judges whether the result of the evaluation of the server 101 satisfies the resource condition for the specified container 301 (S1705).

If the determination unit 1309 judges that the result of the evaluation of the server 101 does not satisfy the resource condition for the container 301, the determination unit 1309 judges whether there is an unspecified server 101 (S1707). If the determination unit 1309 judges that there is an unspecified server 101, the process returns to step S1703 and repeats the above-described steps.

In contrast, if the determination unit 1309 judges that there is not an unspecified server 101, the notification unit 1311 outputs a resource shortage notification (S1709). For example, the notification unit 1311 displays a screen indicating the resource shortage notification on a display. The main process is then terminated.

The description returns to step S1705. If the determination unit 1309 judges in step S1705 that the result of the evaluation of the server 101 satisfies the resource condition for the container 301, the determination unit 1309 determines the server 101 as the deployment destination for the container 301 (S1711). The determination unit 1309 writes the deployment destination server 101 in the loading configuration file in association with the name of the deployment target container 301.

The determination unit 1309 judges whether there is an unspecified container 301 (S1713). If the determination unit 1309 judges that there is an unspecified container 301, the process returns to step S1701 and repeats the above-described steps.

In contrast, if the determination unit 1309 judges that there is not an unspecified container 301, the activation unit 1313 delivers the loading configuration file to the container management tool 809 and activates the container management tool 809 (S1715).

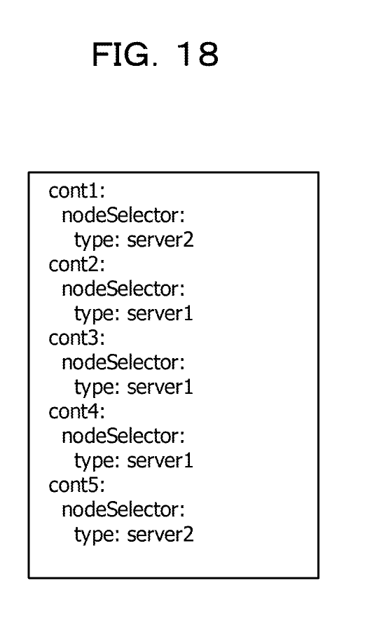

FIG. 18 illustrates an example of the loading configuration file generated in this embodiment. In this example, unlike the example of the loading configuration file illustrated in FIG. 7, the server 101b by the server name of server2 is designated as the deployment destination for the container 301a by the container name of cont1. The server 101a by the server name of server1 is designated as the deployment destination for the container 301b by the container name of cont2. The deployment designations for the container 301c by the container name of cont3, the container 301d by the container name of cont4, and the container 301e by the container name of cont5 are the same as those in FIG. 7.

The container management tool 809 transmits a container loading instruction to the loading unit 801 based on the loading configuration file as described above. After the completion of the loading of the containers 301, the container management tool 809 transmits a loading completion notification to the activation unit 1313.

Thereafter, the activation unit 1313 receives the loading completion notification from the container management tool 809 (S1717), and the main process is terminated.

According to this embodiment, an appropriate container deployment destination may be determined automatically.

Further, a more appropriate information processing apparatus may be selected as the deployment destination for a container 301 including a program that executes a process using a device.

### Embodiment 2

In Embodiment 2, an example of using conditions for the apparatus resources and the apparatus performances of a server 101 will be described.

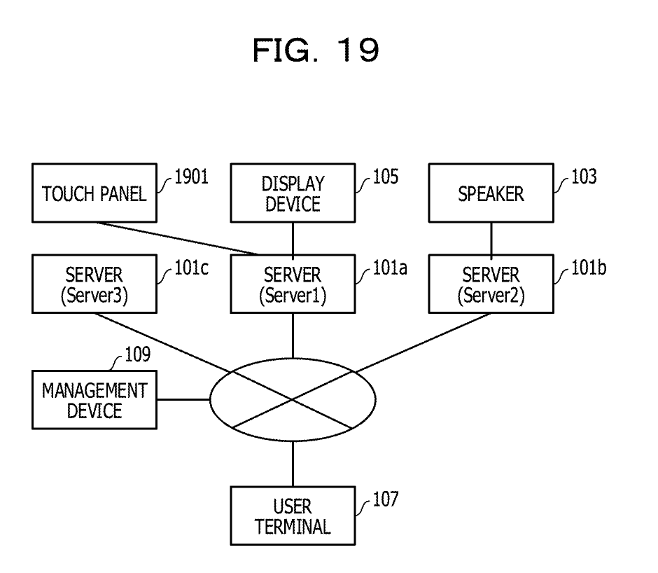

FIG. 19 illustrates an example configuration of a network and devices. In this example, a touch panel 1901 and the display device 105 are connected to the server 101a. The speaker 103 is connected to the server 101b.

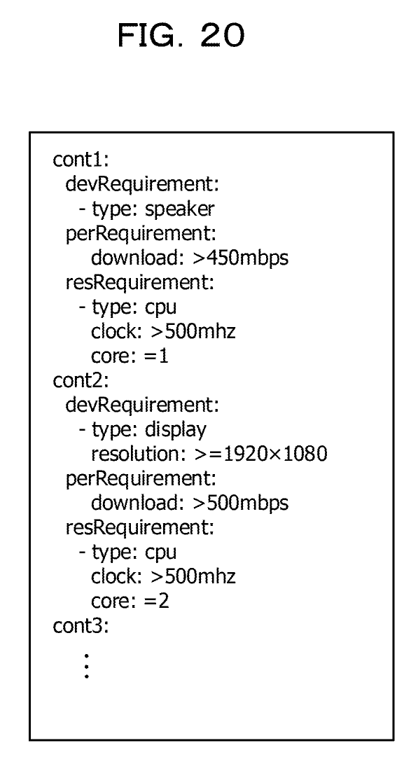

FIG. 20 illustrates an example of a resource request file in Embodiment 2. The resource request file designates apparatus resources and apparatus performances requested on a per container 301 basis.

This example illustrates that the speaker 103, a download performance with a transmission rate of 450 Mbps or higher, and one CPU core with an operating frequency of 500 MHz or higher are necessities for the container 301a by the container name of cont1. The example illustrates that the display device 105 with resolutions of 1920×1080 or higher, a download performance with the transmission rate of 500 Mbps or higher, and two CPU cores with the operating frequency of 500 MHz or higher are necessities for the container 301b by the container name of cont2. The download performance condition is an example of an apparatus performance condition. The CPU condition is an example of an apparatus resource condition.

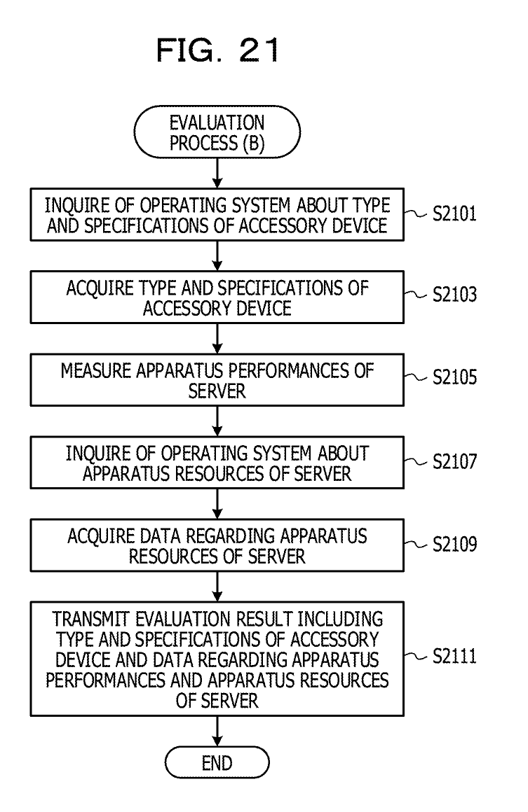

In this embodiment, the evaluation unit executes an evaluation process (B) instead of the evaluation process (A). FIG. 21 illustrates the flow of the evaluation process (B). The evaluation unit inquires of the operating system 401 about the type and specifications of an accessory device (a device connected to the server 101) (S2101) and acquires the type and specifications of the accessory device (S2103).

In this example, the type of the accessory device is one of the touch panel 1901, the speaker 103, and the display device 105. If the resource request file includes the touch panel 1901, the evaluation unit also acquires the resolutions of the touch panel 1901 from the operating system 401. If the resource request file includes the display device 105, the evaluation unit also acquires the resolutions of the display device 105 from the operating system 401. The evaluation unit then sets the type and specifications of each accessory device in an evaluation result.

The evaluation unit measures the apparatus performances of the server 101 (S2105). In this example, the evaluation unit measures a CPU performance, a file write performance, a file read performance, a download performance, and an upload performance. The CPU performance is represented by, for example, unixbench scores. The evaluation unit then sets the apparatus performances of the server 101 in the evaluation result.

The evaluation unit inquires of the operating system 401 about the apparatus resources of the server 101 (S2107) and acquires data regarding the apparatus resources of the server 101 (S2109).

In this example, the evaluation unit acquires the operating frequency of the CPU, the number of cores of the CPU, memory capacity, and disk capacity from the operating system 401. The evaluation unit sets the data regarding the apparatus resources of the server 101 in the evaluation result.

The evaluation unit transmits the evaluation result including the types and specifications of the accessory device and the data regarding the apparatus performances and the apparatus resources of the server (S2111).

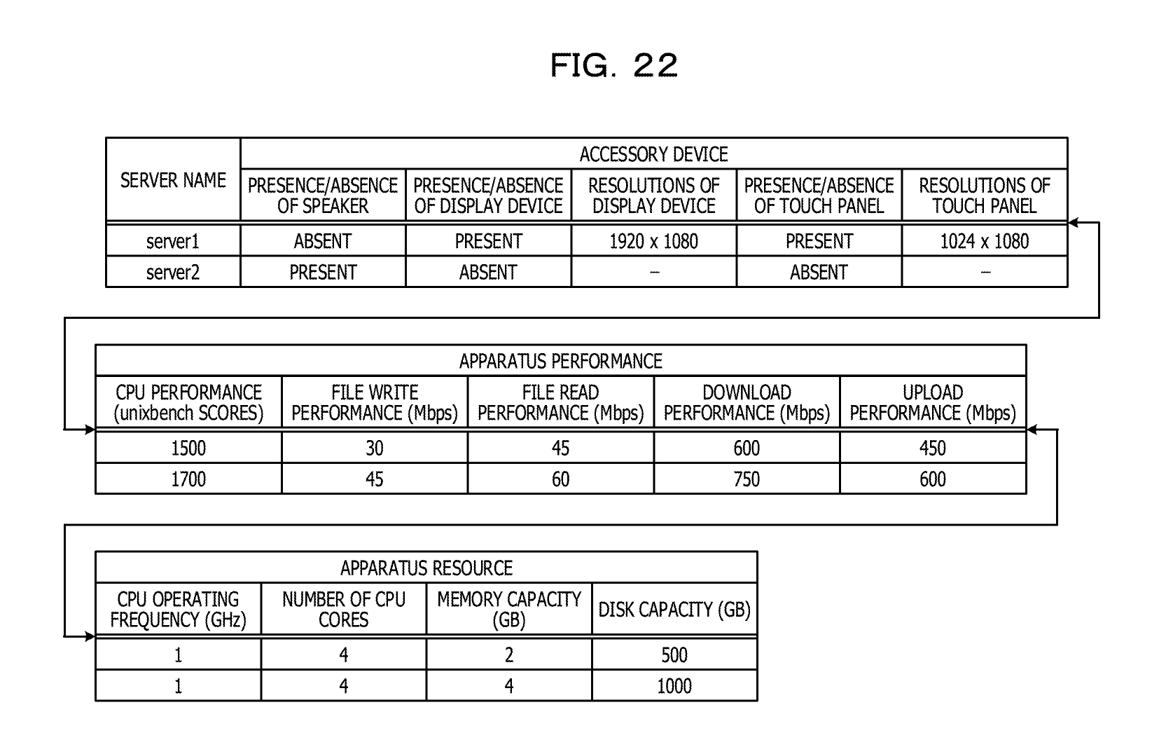

FIG. 22 illustrates an example of an evaluation result table in Embodiment 2. The evaluation result table in Embodiment 2 has fields where the names of the servers 101 are set, fields for accessory devices, fields for apparatus performances, and fields for apparatus resources.

The fields for accessory devices include a field where the presence or absence of the speaker 103 are set, a field where the presence or absence of the display device 105 are set, a field where the resolutions of the display device 105 are set, a field where the presence or absence of the touch panel 1901 are set, and a field where the resolutions of the touch panel 1901 are set.

The fields for the apparatus performances include a field where a CPU performance is set, a field where a file write performance (Mbps) is set, a field where a file read performance (Mbps) is set, a field where a download performance (Mbps) is set, and a field where an upload performance (Mbps) is set.

The fields for the apparatus resources include a field where the operating frequency of the CPU is set, a field where the number of cores of the CPU is set, a field where memory capacity is set, and a field where disk capacity is set.

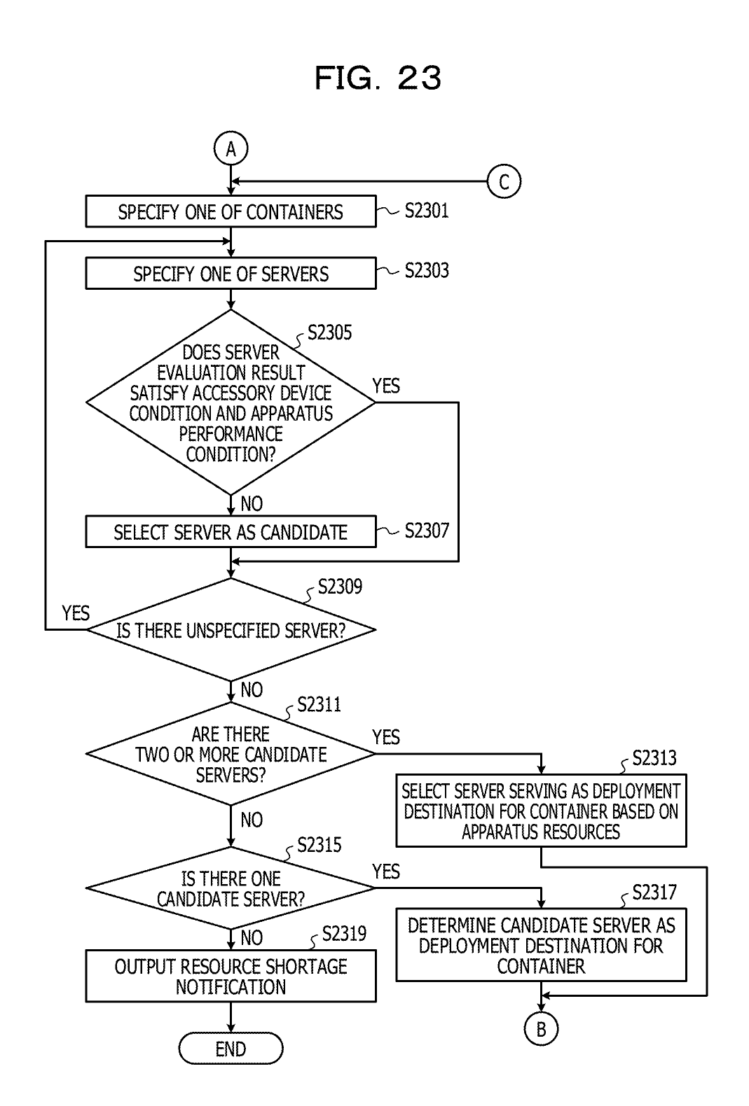

A main process in Embodiment 2 will be described. In the main process in Embodiment 2, steps S1401 to S1411 in FIG. 14 are performed as in Embodiment 1. If the deployment unit 1305 judges that there is not an unspecified server 101 in step S1411, the process moves to step S2301 illustrated in FIG. 23 via the connector A.

FIG. 23 will be described. The determination unit 1309 specifies one of the containers 301, for example, based on the resource request file (S2301).

The determination unit 1309 specifies one of the servers 101 (S2303). Based on the evaluation result of the server 101 and the resource request file, the determination unit 1309 judges whether the result of the evaluation of the server 101 satisfies an accessory device condition and an apparatus performance condition (S2305).

If the determination unit 1309 judges that the result of the evaluation of the server 101 satisfies an accessory device condition and an apparatus performance condition, the determination unit 1309 selects the server 101 as a candidate (S2307), and the process moves to step S2309. In contrast, if the determination unit 1309 judges that the result of the evaluation of the server 101 does not satisfy an accessory device condition and an apparatus performance condition, the determination unit 1309 does not select the server 101 as a candidate, and the process moves to step S2309 without doing anything.

The determination unit 1309 judges whether there is an unspecified server 101 (S2309). If the determination unit 1309 judges that there is an unspecified server 101, the process returns to step S2303 and repeats the above-described steps.

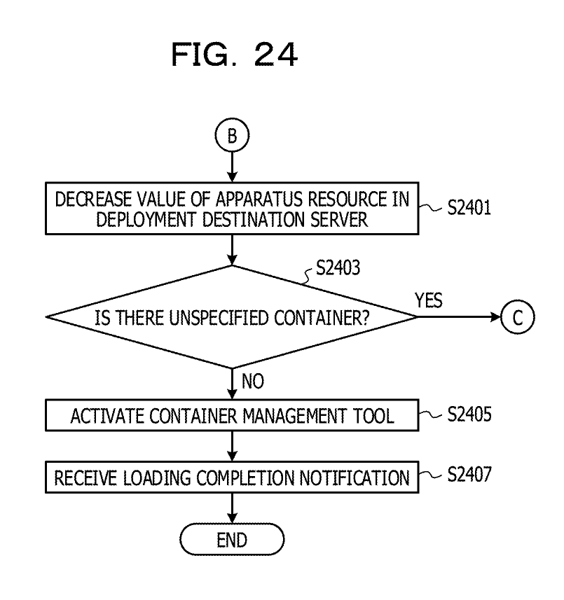

In contrast, if the determination unit 1309 judges that there is not an unspecified server 101, the determination unit 1309 judges whether there are two or more candidate servers 101 (S2311). If there are two or more candidate servers 101, the determination unit 1309 selects one of the servers 101 that serves as a deployment destination for the container 301 based on the apparatus resources (S2313). The process then moves to step S2401 in FIG. 24 via a connector B. In this example, the determination unit 1309 selects one of the servers 101 that has a larger value of a currently available apparatus resource. However, the determination unit 1309 may select one of the servers 101 that has a smaller value of a currently available apparatus resource. If no server 101 satisfies the apparatus resource condition, the process may move to step S2319. The value of the currently available apparatus resource is updated in step S2401 in FIG. 24 (described later).

In contrast, if there are not two or more candidate servers 101, the determination unit 1309 judges whether there is one candidate server 101 (S2315). If there is one candidate server 101, the determination unit 1309 determines the candidate server 101 as the deployment destination for the container 301 (S2317). The process moves to step S2401 in FIG. 24 via the connector B. If the candidate server 101 does not satisfy the apparatus resource condition, the process may move to step S2319.

If the determination unit 1309 judges that there is no candidate server 101 in step S2315, the notification unit 1311 outputs a resource shortage notification (S2319). For example, the notification unit 1311 displays a screen indicating the resource shortage notification on the display. The main process is then terminated.

FIG. 24 will be described. The determination unit 1309 decreases the value of the apparatus resource in the deployment destination server 101 (S2401). For example, the memory utilization for the container 301 is subtracted from the memory capacity of the deployment destination server 101. Alternatively, the HDD utilization for the container 301 is subtracted from the HDD capacity of the deployment destination server 101. Still alternatively, the number of cores of the CPU to be used for the container 301 is subtracted from the number of cores of the CPU of the deployment destination server 101.

The determination unit 1309 judges whether there is an unspecified container 301 (S2403). If the determination unit 1309 judges that there is an unspecified container 301, the process returns to step S2301 in FIG. 23 via a connector C.

In contrast, if the determination unit 1309 judges that there is not an unspecified container 301, the activation unit 1313 delivers the loading configuration file to the container management tool 809 and activates the container management tool 809 (S2405).

The container management tool 809 transmits a container loading instruction to the loading unit 801 based on the loading configuration file as described above. After the completion of the loading of the containers 301, the container management tool 809 transmits a loading completion notification to the activation unit 1313.

Thereafter, the activation unit 1313 receives the loading completion notification from the container management tool 809 (S2407), and the main process is terminated.

According to this embodiment, a more appropriate server 101 may be selected as a deployment destination for a container 301 including a program dependent on the apparatus resources or the apparatus performances of the server 101.

Each evaluation container 1201 may reside on the corresponding server 101. The deployment unit 1305 may start the evaluation program 1203 in step S1407 in FIG. 14.

The resource request file may be set providing that each accessory device is exclusively used for the corresponding server 101.

The embodiments have heretofore been described but are not limited to these embodiments. For example, the above-described functional block configuration does not coincide with the program module configuration in some cases.

The configuration of each memory area is an example and does not necessarily have to be the configuration as described above. Further, as long as a process flow does not have a different result, the order of steps may be changed, and a plurality of steps may be performed in parallel.

The servers 101 and the management device 109 that are described above are each a computer. As illustrated in FIG. 25, a memory 2501, the CPU 2503, a hard disk drive (HDD) 2505, a display controller 2507 connection to a display 2509, a drive device 2513 for a removable disk 2511, an input device 2515, a communication controller 2517 for connection to a network are connected to each other via a bus 2519. The operating system (OS) and application programs for executing the processes in the embodiments are stored in the HDD 2505. When being run by the CPU 2503, the OS and the application programs are read from the HDD 2505 to be loaded into the memory 2501. The CPU 2503 controls the display controller 2507, the communication controller 2517, or the drive device 2513 in accordance with the content of a process by an application program and causes predetermined operations to be performed. Data in the course of processing is mainly stored in the memory 2501 but may be stored in the HDD 2505. In the embodiments, the application programs for executing the above-described processes are distributed in such a manner as to be stored in the computer-readable removable disk 2511 and are then installed on the HDD 2505 from the drive device 2513. The application programs are installed on the HDD 2505 via a network such as the Internet and the communication controller 2517 in some cases. The computer as described above implements the various functions described above in such a manner that the hardware such as the CPU 2503 and the memory 2501 and the programs such as the OS and the application programs cooperate with each other like an organic whole.

The above-described embodiments are summarized as follows.

An information processing system according to each embodiment includes (A) a plurality of information processing apparatuses including a container virtualization infrastructure, (B) a deployment unit that deploys, on each of the plurality of information processing apparatuses, an evaluation container including an evaluation program that evaluates a resource of the information processing apparatus, (C) an acquisition unit that acquires data regarding the resource in the information processing apparatus from the evaluation program in the evaluation container deployed on the information processing apparatus, and (D) a determination unit that determines, as a deployment destination for a deployment target container, one of the information processing apparatuses that satisfies a resource condition for the deployment target container.

With this configuration, an appropriate container deployment destination may be automatically determined.

The resource condition may be a condition regarding a device used by the deployment target container.

With this configuration, a more appropriate information processing apparatus may be selected as a deployment destination for a container including a program that executes a process using the device.

The resource condition may be a condition regarding an apparatus resource or an apparatus performance of the information processing apparatus that are necessities for the deployment target container.

With this configuration, a more appropriate information processing apparatus may be selected as the deployment destination for a container including a program dependent on the resource or the performance of the information processing apparatus.

The information processing system may further include (E) a container management unit that deploys the deployment target container on the information processing apparatus determined as the deployment destination.

With this configuration, the container may be deployed more automatically.

A program causing a computer to execute the processes in the information processing system described above may be generated. The program may be stored in a computer-readable storage medium or a memory device such as a flexible disk, a compact disk read-only memory (CD-ROM), a magneto -optical disk, a semiconductor memory, or a hard disk. An intermediate processing result is generally temporarily stored in a memory device such as a main memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising:
a plurality of information processing apparatuses having a container virtualization infrastructure; and
a container management apparatus including:
a memory and
a processor coupled to the memory and the processor configured to:
deploy an evaluation container on each of the plurality of information processing apparatuses, the evaluation container including an evaluation program that evaluates a resource of the information processing apparatus,
acquire data regarding the resource in the information processing apparatus from the evaluation program,
specify, based on the data regarding the resource, one of the plurality of information processing apparatuses that satisfies a resource condition for a target container, and
determine the specified information processing apparatus as a deployment destination for the target container.

2. The information processing system according to claim 1,
wherein the resource condition is a condition regarding a device used by the target container.

3. The information processing system according to claim 1,
wherein the resource condition is a condition regarding an apparatus resource or an apparatus performance of the information processing apparatus, the apparatus resource or the apparatus performance being a necessity for the target container.

4. A container management apparatus comprising:
a memory;
a processor coupled to the memory and the processor configured to execute a process, the process including:
deploying an evaluation container on an information processing apparatus, the evaluation container including an evaluation program that evaluates a resource of the information processing apparatus,
acquiring data regarding the resource in the information processing apparatus from the evaluation program,
specifying, based on the data regarding the resource, one of the plurality of information processing apparatuses that satisfies a resource condition for a target container, and
determining the specified information processing apparatus as a deployment destination for the target container.

5. A container management method comprising:
deploying an evaluation container on an information processing apparatus, the evaluation container including an evaluation program that evaluates a resource of the information processing apparatus,
acquiring data regarding the resource in the information processing apparatus from the evaluation program,
specifying, based on the data regarding the resource, one of the plurality of information processing apparatuses that satisfies a resource condition for a target container, and
determining the specified information processing apparatus as a deployment destination for the target container.
